(19) United States
(12) Patent Application Publication
(10) Pub. No.: US 2014/0035404 A1
(43) Pub. Date: Feb. 6, 2014

(54) ANGLED WELD END TURNS FOR COOLANT ACCESS

(71) Applicants: Colin Hamer, Noblesville, IN (US); Bradley Chamberlin, Pendleton, IN (US)

(72) Inventors: Colin Hamer, Noblesville, IN (US); Bradley Chamberlin, Pendleton, IN (US)

(21) Appl. No.: 13/565,525

(22) Filed: Aug. 2, 2012

(51) Int. Cl. H02K 3/24; H01R 43/00

(52) U.S. Cl. 310/64; 29/825

(57) ABSTRACT

An electric machine includes a stator core having a plurality of circumferentially-oriented slot positions, each slot position having a plurality of radially-oriented slots, each slot extending longitudinally through the core. The stator core has a plurality of conductor segments each extending through at least one of the slots. When a slot position is populated with at least two conductor segments, at least two exterior conductor portions exiting the slot position are angled radially apart from one another by more than one degree. A method of cooling an electric machine includes providing coolant access to embedded conductor end turn portions of a stator having circumferentially spaced slot positions by radially spreading exterior conductor portions exiting populated ones of the slot positions.

### BACKGROUND

The present invention is directed to improved thermal performance of an electric machine and, more particularly, to structure and methods of manufacturing for improving reliability and/or performance of a machine having a stator formed with conductor segments welded at end turns.

An electric machine is generally structured for operation as a motor and/or a generator, and may have electrical windings, for example in a rotor and/or in a stator. Such windings may be formed with conductor wire as solid conductor segments or bars that are shaped to be securely held within a core, bobbin, or other structure. The conductors may be formed of copper, aluminum, or other conductive material by various manufacturing operations, including casting, forging, welding, bending, heat treating, coating, jacketing, or other appropriate processes. The conductors are typically formed as individual segments that are assembled into a stator and then welded together.

The stator has a cylindrical core that secures the conductor segments of the stator windings in slots disposed around the circumference of the core. Each angular position around the circumference typically has a plurality of radially aligned slot layers. For example, the radially innermost space for a given angular position is a first layer, the next radially outward space for the angular position is a second layer, etc. In many electric machines, the stator core is densely populated so that each angular position has several layers of conductor segments installed therein. Various wiring configurations may be utilized for the windings of a stator.

In a densely packed stator operating at a high performance level, excessive heat may be generated in the stator windings. In some applications, heat must be actively removed to prevent it from reaching impermissible levels that may cause damage and/or reduction in performance or life of the motor. Various apparatus and methods are known for removing heat. One exemplary method includes providing the electric machine with a water jacket having fluid passages through which a cooling liquid, such as water, may be circulated to remove heat. Another exemplary method may include providing an air flow, which may be assisted with a fan, through or across the electric machine to promote cooling. A further exemplary method may include spraying or otherwise directing oil or other coolant directly onto end turns of a stator. Although various structures and methods have been employed for cooling an electric machine, improvement remains desirable.

### SUMMARY

It is therefore desirable to obviate the above-mentioned disadvantages by providing a stator assembly configured to allow a coolant to access and thereby remove heat from end turn portions such as “hot spots” located within an end turn bundle. By increasing the stator end turns' surface area that may be accessed by a coolant, performance, reliability, and durability of an electric machine are thereby increased.

According to an exemplary embodiment, an electric machine includes a stator core having a plurality of circumferentially-oriented slot positions, each slot position having a plurality of radially-oriented slots, each slot extending longitudinally through the core. Such electric machine also includes a plurality of conductor segments each extending through at least one of the slots. When a slot position is populated with at least two conductor segments, at least two conductor portions protruding from the slot position are angled radially apart from one another by more than one degree.

According to another exemplary embodiment, a method of forming an electric machine includes providing a stator core having a plurality of circumferentially-oriented slot positions, each slot position having a plurality of radially aligned slots, each slot extending longitudinally through the core. Such method also includes placing a plurality of conductor segments through the slots so that at least two legs of the segments protrude from an axial end of the stator core at each populated slot position and, at each populated slot position, angling the protruding portion of at least one of the legs radially outward by more than one degree.

According to a further exemplary embodiment, a method of cooling an electric machine includes providing coolant access to embedded conductor end turn portions of a stator having circumferentially spaced slot positions by radially spreading exterior conductor portions protruding from populated ones of the slot positions.

The foregoing summary does not limit the invention, which is defined by the attached claims. Similarly, neither the Title nor the Abstract is to be taken as limiting in any way the scope of the claimed invention.

### BRIEF DESCRIPTION OF THE DRAWING FIGURES

The above-mentioned aspects of exemplary embodiments will become more apparent and will be better understood by reference to the following description of the embodiments taken in conjunction with the accompanying drawings, wherein:

FIG. 1 is a schematic view of an electric machine;

FIG. 2A is a top plan view of a stator body of an electric machine, and FIG. 2B is an enlarged segment thereof;

FIG. 3A is a cross-sectional view of a conductor bar and FIG. 3B is a conductor bar segment;

FIG. 4 is a perspective view of a pair of hairpin type conductor segments being inserted into slots of a stator core;

FIG. 5 is a partial perspective view of the weld connection end of a stator core populated with four conductor segments per slot location;

FIG. 6 is a cross-sectional plan view of an electric machine, showing four adjacent populated slots of a stator core;

FIG. 7A is a cross-sectional view of a conventional stator slot position having eight conductor segments extending axially out of a stator core;

FIG. 7B is a partial perspective view of a conventional stator end turn portion;

FIG. 7C is a partial perspective view of a conventional stator end turn portion having radial spaces between adjacent conductor segments;

FIG. 8 is a partial cross-sectional plan view of an electric machine having angled weld end turns for coolant access, according to an exemplary embodiment;

FIGS. 9A-9H illustrate different end turn configurations allowing coolant access to be provided thereto, according to exemplary embodiments;

FIG. 10 is a partial perspective cutaway view of stator end turns, according to an exemplary embodiment; and

FIG. 11 is an elevation view showing welded end turns in a configuration allowing coolant access to individual conductors.

Corresponding reference characters indicate corresponding or similar parts throughout the several views.

### DETAILED DESCRIPTION

The embodiments described below are not intended to be exhaustive or to limit the invention to the precise forms disclosed. Rather, the embodiments are chosen and described so that others skilled in the art may appreciate and understand the principles and practices of these teachings.

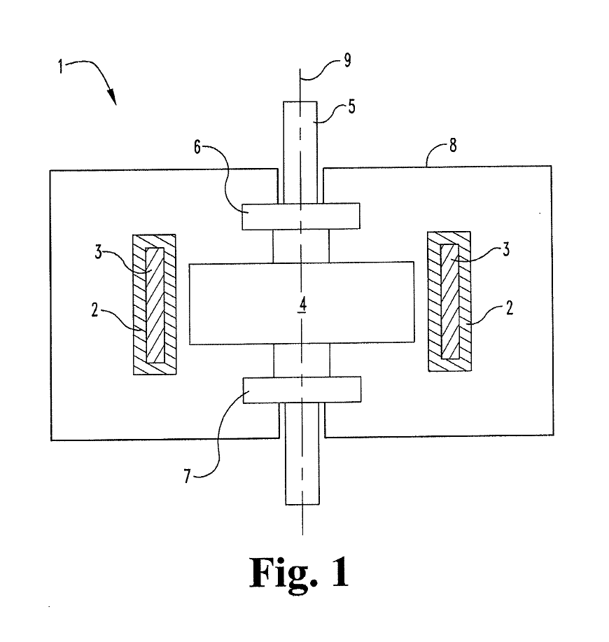

FIG. 1 is a schematic view of an exemplary electric machine 1 having a stator 2 that includes stator windings 3 such as one or more coils. An annular rotor body 4 may also contain windings and/or permanent magnets and/or conductor bars such as those formed by a die-casting process. Rotor body 4 is part of a rotor that includes an output shaft 5 supported by a front bearing assembly 6 and a rear bearing assembly 7. Bearing assemblies 6, 7 are secured to a housing 8. Typically, stator 2 and rotor body 4 are essentially cylindrical in shape and are concentric with a central longitudinal axis 9. Although rotor body 4 is shown radially inward of stator 2, rotor body 4 in various embodiments may alternatively be formed radially outward of stator 2. Electric machine 1 may be an induction motor/generator or other device. In an exemplary embodiment, electric machine 1 may be a traction motor for a hybrid or electric type vehicle. Housing 8 may have a plurality of longitudinally extending fins (not shown) formed to be spaced from one another on a housing external surface for dissipating heat produced in the stator windings 3.

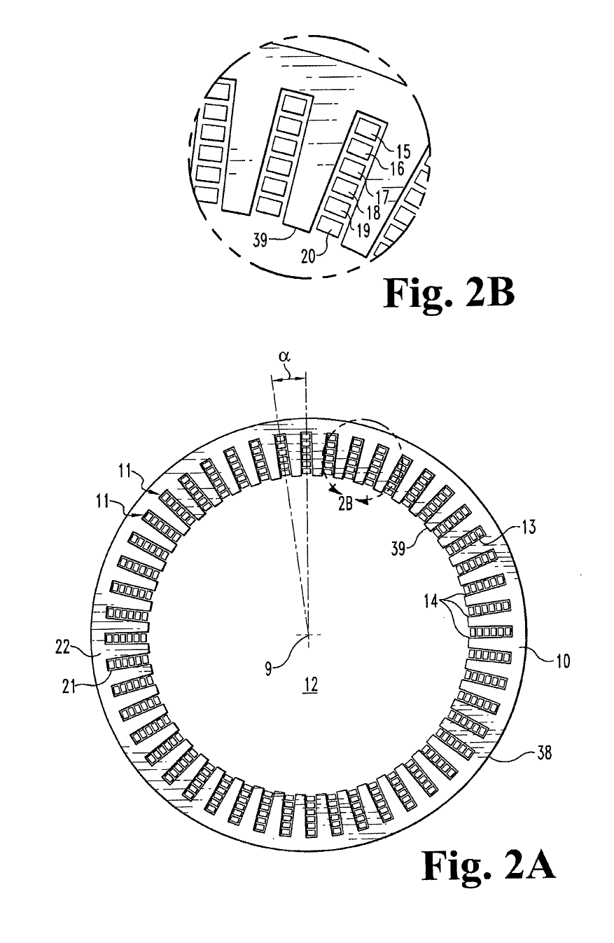

FIG. 2A is a top plan view of an exemplary cylindrical stator body 10 of an electric machine 1, and FIG. 2B is an enlarged portion thereof. For example, stator body 10 may be cast aluminum, molded resin, an iron core fabricated by stacking individual magnetic steel sheet laminates, or any suitable core. A plurality of individual spaced angular portions 11 may be spaced circumferentially at equal intervals about a center axis 9 of stator body 10. One or more conductor passages 13 may be formed along each angular portion 11 to longitudinally extend from each respective slot 14. For example, any appropriate number of individual slots 14 may be radially aligned with one another at a given angular portion 11. As shown, each angular portion 11 has, respecting a radially inward direction, a radially outermost slot position 15, a second radial slot position 16, a third radial slot position 17, a fourth radial slot position 18, a fifth radial slot position 19, and a radially innermost slot position 20. For other illustration purposes, a stator body 10 may have any number of slots for each angular position. Each slot has a sleeve portion 21 axially extending through stator body 10 and outward of the bottom surface (not shown) and top surface 22 of stator body 10. For example, sleeve portion 21 may be formed in a rectangular or other shape and may include material such as inserts and coatings. The circumferential interval of adjacent angular portions 11 defines a slot pitch α. Stator body 10 has a radially outward surface 38 and at least one radially inward surface 39 defining a center stator aperture 12.

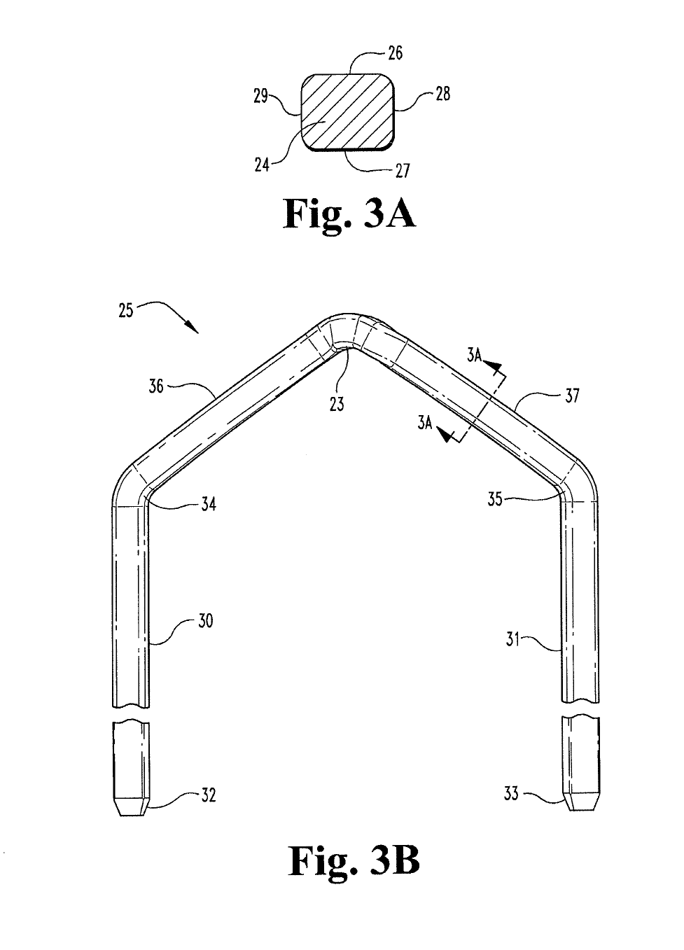

FIG. 3A is a cross-sectional view of an exemplary conductor bar 24 used for forming stator windings such as those used in a traction motor of an electric vehicle. Conductor bar 24 may be formed of copper, aluminum, or other conductive material. For example, in order to provide a higher output for a given motor size, solid copper wire may be selected because of its excellent conductivity. Such solid wire may have a substantially rectangular cross section, thereby maximizing the amount of copper per unit volume of stator 2. Conductor bar 24 may have an approximately rectangular profile with two wide surfaces 26, 27, for example 4 mm wide, and two narrow surfaces 28, 29, for example 3 mm wide. FIG. 3B is a perspective view of an exemplary conductor bar segment 25 having a bent shape for insertion into two slots 14 of stator body 10. A first insertion portion 30 and a second insertion portion 31 extend essentially axially outward from respective distal ends 32, 33 of conductor bar segment 25. Bent portions 34, 35 are respectively formed to define obtuse angles at axially outward ends of insertion portions 30, 31. First and second external portions 36, 37 respectively extend from bent portions 34, 35 and meet to form an obtuse angle defining a center apex portion 23 of conductor segment 25. After being formed into its desired shape, conductor bar segment 25, or portions thereof, may be coated with an electrically insulating and/or other protective coating. An individual conductor bar segment 25 may for example be inserted into stator 2 so that an end 32 is placed into a slot 14 at any given radial position 15-20 at a first angular location 11 and an end 33 is placed into a slot 14 at any given radial position 15-20 at a second angular location 11 (see, e.g., FIG. 2A). Depending on a particular application, conductor bar segment 25 may be formed so that insertion portions 30, 31 are essentially parallel and consistently spaced apart, for example by 55 mm. Two conductor bar segments 25 of the same stator coil may be placed into a single slot 14 and inside a single sleeve 21. In some embodiments, conductor bar segments 25 of different stator coils may be placed into the same slot 14.

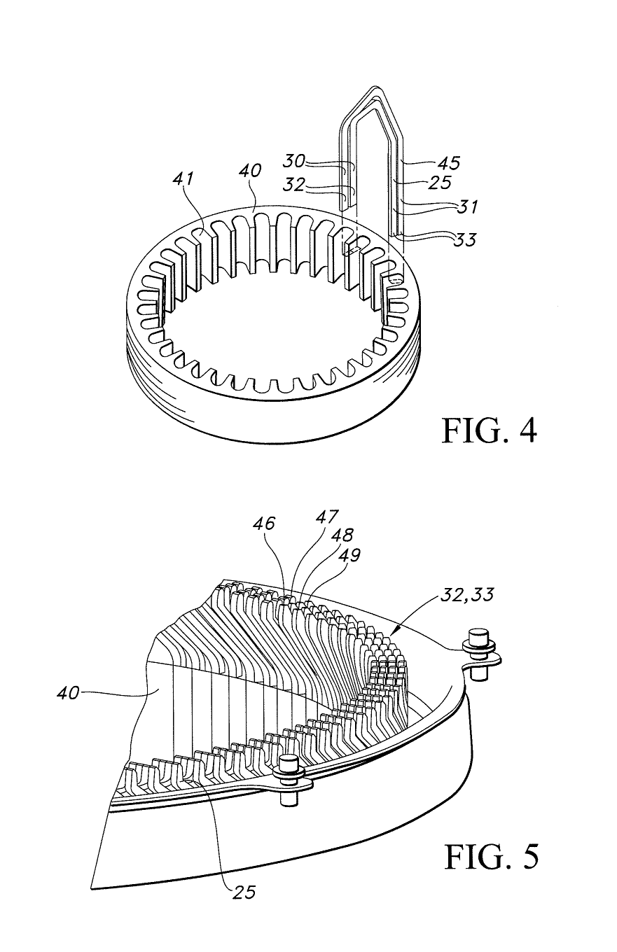

FIG. 4 is a perspective view of an exemplary stator assembly having a stator core 40 with radially oriented slots 41 evenly spaced around an inner circumference thereof. Conductor segments 25, 45 are preformed, coated, and then axially inserted into a pair of slots 41 so that respective insertion portions 30, 31 are longitudinally aligned. Portions of conductor segments 25, 45 may be electrically insulated from one another by coating, by being placed into insulating sleeves (not shown), or the like. Although conductor segments 25, 45 are shown with different size and with a hairpin structure, they may alternatively be formed as individual straight pieces. The bend portion of a hairpin shaped conductor segment may be referred to herein as an apex 23 (e.g., FIG. 3B). The respective segment ends 32, 33 are left uncoated until a welding operation has been completed. Depending on the chosen wiring configuration, individual conductor segments 25, 45 may be inserted in stages. For example, a large number of conductor segments 25, 45 may have differing shapes and sizes to accommodate crossover, interleaving, layering, input/output, and various serial/parallel wiring patterns. Installation while avoiding damage to insulation and coating may require that one or more subsets be partially installed in a pre-population where conductor segments 25, 45 are not fully seated but are only partially pushed in. When a stage of conductor segments 25, 45 has been pre-populated, the set may then be pressed into seating position as a group.

When all conductor segments 25, 45 have been fully seated in stator core 40, ends 32, 33 are twisted into position for a subsequent welding process. FIG. 5 is a partial perspective view of an exemplary stator assembly having four conductor segments 25 at each angular position. At any angular position/slot, there are an inner conductor end 46, a next outward conductor end 47, a next outward conductor end 48, and an outer conductor end 49. Ends 32, 33 of respective conductor segments 25 have been twisted so that pairs of ends 32, 33 are contiguous. Such pairs are then welded to form interconnections between conductor segments 25, 45. For example, resistance welding or any suitable welding process may be used.

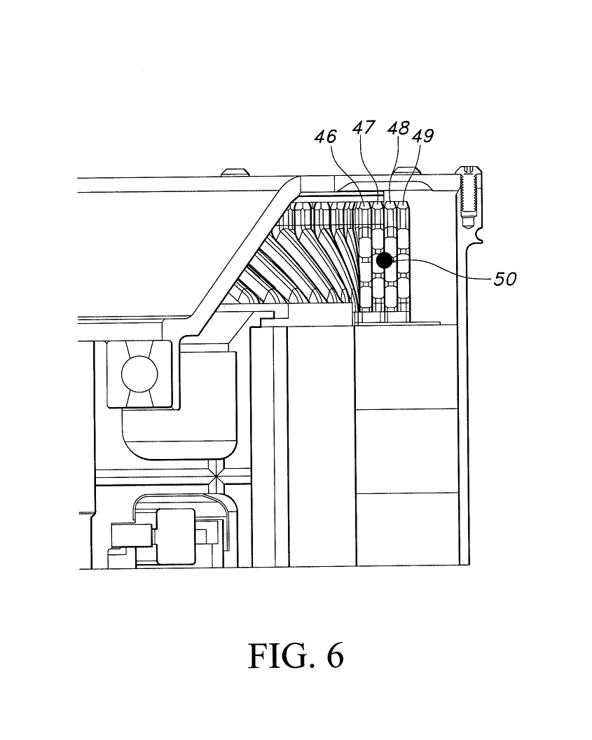

FIG. 6 is a partial cross-sectional plan view of an exemplary assembled stator assembly. Four conductor ends 46, 47, 48, 49 are radially aligned at an angular slot position of a stator core 51. When electric machine 1 has a high power density, the dense packing of stator windings creates substantial heat. Although coolant may be directly provided to the end turn portions of stator 2 such as by immersion in oil or other coolant, the heat becomes trapped in a “hot spot” 50. In particular, the hottest locations in the end turn bundle are those spots where coolant access is blocked by the dense population of conductor segments 25, 45. In the illustrated example having four radial locations per slot, the maximum heat was found to occur at hotspot 50 between conductor end 47 and conductor end 48. It was also observed that such maximum temperature was relatively higher at hotspots 50 for the welded ends compared with the apex ends.

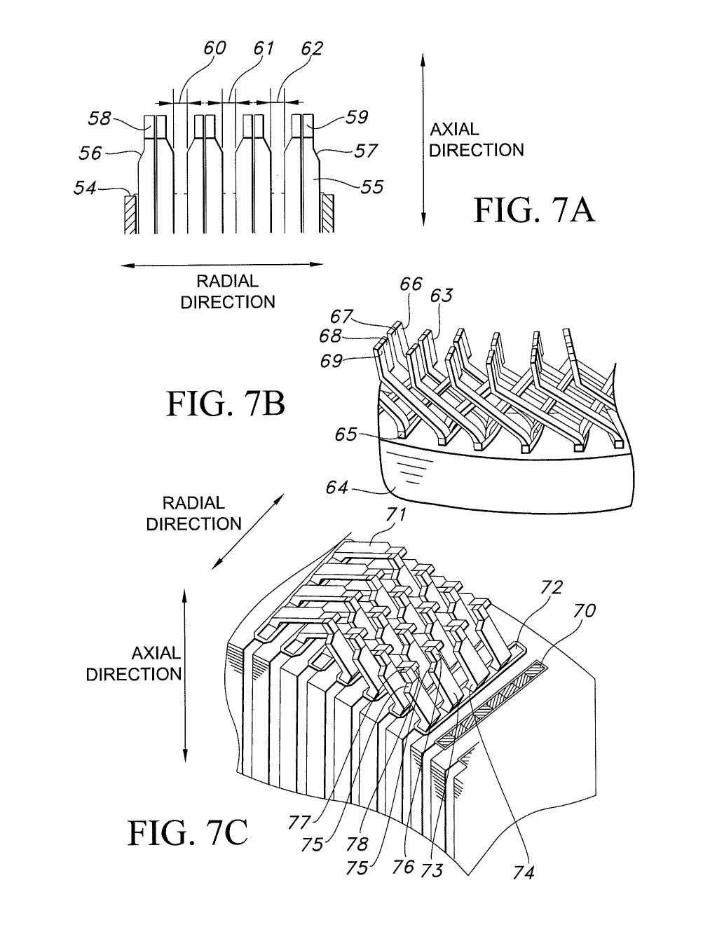

FIGS. 7A-7C illustrate three respective examples of conventional stator end turn portions. FIG. 7A is a cross-sectional view of a conventional stator end turn portion having eight conductor segments 55 at an angular slot position of a stator core 54. Conductor segments 55 are divided into four pairs. Conductor segments 55 are formed to have tapered portions 56, 57 that reduce conductor size leading to respective distal welding ends 58, 59, which are placed in contiguous abutment. A welding operation connects welding ends 58, 59 for each pair of conductor segments 55, leaving spaces 60, 61, 62 between the respective welded pairs. In operation, this configuration provides room for coolant flow in spaces 60, 61, 62. However, the radial length of the slot in stator core 54 is required to be longer by the sum of spaces 60, 61, 62, which reduces performance by reducing the conductor density. In addition, tapering of conductor segments 55 reduces current capacity, further reducing power density.

FIG. 7B is a partial perspective view of a conventional stator end turn portion having four conductor segments 63 at each angular slot position of a stator core 64. Alternate conductor segments 63 at each slot extend in opposite circumferential directions, and conductor portions are interwoven between radial layers as they extend axially outward from slot liners 65. Groups of four conductor segments 63 are aligned radially. The radially inner conductor end 66 is paired with and welded to the next radially outward conductor end 67. The next radially outward conductor end 68 is paired with and welded to the next radially outward conductor end 69. In operation, this configuration provides room for coolant flow in the radial space between conductor ends 67, 68, in the spaces between circumferentially spaced rows of welded conductor ends, and within the interwoven bundle of conductor segments 63 between stator core 64 and welded conductor ends 66, 67, 68, 69. However, the unused space in such end turn portion is overly large, and the configuration is therefore not optimized for maximizing power density while providing adequate cooling.

FIG. 7C is a partial perspective of yet another conventional stator end turn portion. Each slot 70 has eight radial positions, or layers. Each slot 70 has four conductor segments 71, each spaced a layer apart so that conductor segments 71 alternate radially with spaces 72. For example, conductor segment 73 is spaced a layer apart from conductor segment 74. Each conductor segment 71 has a tapered portion 75 that reduces conductor size to a smaller rectangular dimension of each distal end 76. At each segment connection, orthogonally disposed welding ends 77, 78 are formed to be contiguous with one another and are then welded together. In operation, this configuration provides room for coolant flow in the radial spaces between respective conductor segments, and in the spaces between circumferentially slots. The configuration has a reduced axial height. However, the use of alternating spaces in each slot and the reduction of conductor size at tapered portions 75 substantially reduce power density, and the configuration is therefore not suitable for applications that seek to maximize power density while providing adequate cooling.

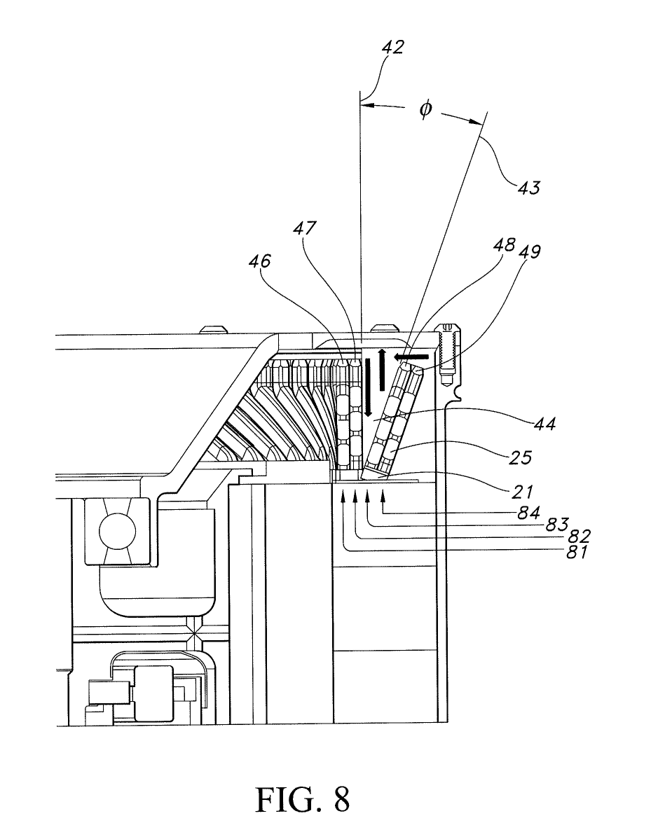

FIG. 8 is a partial cross-sectional view of a stator assembly according to an exemplary embodiment. Four radial locations per slot 14 each have a conductor segment 25 axially extending out of insulating sleeves 21. At each angular position/slot 14 of a stator body 10, there is an inner radial position 81, a next outward radial position 82, a next outward radial position 83, and an outer radial position 84. Each radial position 81-84 may have one or more conductor segments 25 stacked axially atop one another according to a chosen wiring pattern. The radially outward pair of conductor segments, at radial positions 83, 84 is angled radially outward so that conductor ends 48, 49 extend at an angle φ away from the axial direction shown at radius 42. For example, angle φ may be defined between the adjacent outer surfaces of conductor ends 47, 48. In the illustrated example, line 43 represents an annular perimeter of a volume 44 between conductor ends 47, 48. In operation, as shown by arrows in FIG. 8, the flow of coolant in volume 44 is able to reach all the way to the apex of angle φ near sleeves 21. In addition, coolant is able to flow in a radial direction axially outward of conductor ends 48, 49 due to the extra axial space provided by such conductor ends being angled.

Various methods may be utilized for forming conductor ends 48, 49 at an angle. For example, the connections between conductor segments 25, 45 may first be created by a process that may include TIG welding, plasma welding, resistance welding, fusing, fusing type brazing, resistance type brazing, and/or another bonding operation. Then, the welded conductors at radial positions 83, 84 may be gradually urged into their desired position at angle φ by slowly forcing a wedge (not shown) between conductor ends 47, 48. In such a case, a rotary machine may be utilized for gradually inserting an annular wedge around the outside of radius 42. Optionally, one or more wedges may be inserted to bend a subset of all welded conductor ends 48, 49. For example, conductor ends 48, 49 may be welded together and then bent as a pair, one angular position at a time around the circumference of stator 2. In another example, a conductor end shaping machine (not shown) used for bending, weaving, spacing, and otherwise preparing conductor ends 46-49 and placing them into their final position for welding, may be adapted to seize and twist conductors at radial position 84 and to then bend those conductors radially outward to angle φ. Next, the shaping machine seizes and twists the conductors at radial position 83 and bends them outward to angle φ. After being placed into position at angle φ, conductor ends 48, 49 may be welded together at selected connection locations. In a further example, a protective sheet (not shown) is temporarily placed between conductor ends 48 and conductor ends 49 to prevent damage to the conductors, then conductor ends 48, 49 are bent to angle φ as an unwelded pair, then the protective sheet is removed, and then conductor ends 48, 49 are welded together. In a still further example, a conductor shaping machine forms an array of conductor segments at radial positions 46-49 for a subset of all angular positions of stator 2, then a portion of the subset are wedged outward to angle φ, and then selected connections of the angled portion are welded together. The process continues until all conductor ends 48, 49 are angled and welded. Shaping, bending, and welding steps may be performed in any suitable order to accommodate interwoven and complex stator wiring configurations.

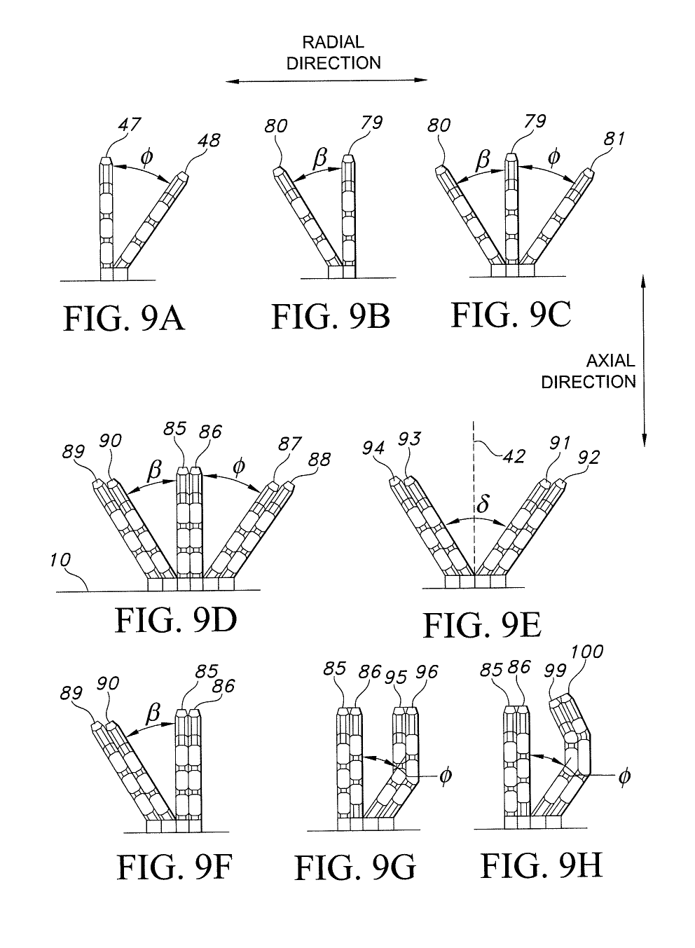

FIGS. 9A-9H illustrate exemplary embodiments for improving coolant access to end turns of a stator 2. The symbols φ, β, and δ are used for convenience and are not limiting, whereby corresponding angles in a given embodiment may have any appropriate value. In FIG. 9A, conductor end(s) 47 are oriented in an axial direction, and conductor end turn portion(s) 48 are angled radially outward at an angle φ. In FIG. 9B, conductor end turn portion(s) 79 are oriented in an axial direction and conductor end(s) 80 are angled radially inward at an angle β formed therebetween. In FIG. 9C, the configuration of FIG. 9B adds conductor end turn portion(s) 81, formed at an angle φ radially outward from conductor end(s) 79. In each case, individual conductors' radial locations are increasingly spaced from one another in the axially outward direction, while the radial spacing remains substantially unchanged at the respective stator portions where conductors exit sleeves 21. Coolant may thereby be provided to remove heat from individual end turns.

FIG. 9D illustrates an end turn configuration having three pairs of conductor ends. Conductor end turn portion(s) 85, 86 extend axially away from stator body 10. Conductor end turn portion(s) 87, 88 extend away in a radially outward direction from stator body 10 at an angle φ away from the axial direction. Conductor end turn portion(s) 89, 90 extend away in a radially inward direction from stator body 10 at an angle β away from the axial direction. Each radial side of each conductor end turn pair may thereby be provided access to coolant.

FIG. 9E shows a stator end turn configuration with a first pair of conductor end turn portions 91, 92 and a second pair of conductor end turn portions 93, 94. The first and second pairs are spread apart from one another by an angle δ. For example, the first and second pairs of conductor ends may be evenly spread apart so that the axial direction, shown at line 42, bisects angle δ. In FIG. 9F, conductor end turn portions 85, 86 are oriented in an axial direction and conductor ends 89, 90 are angled radially inward at an angle β formed between conductor location 85 and conductor location 90. In FIG. 9G, conductor end turn portion(s) 85, 86 extend axially away from stator body 10. Conductor end turn portion(s) 95 and conductor end turn portion(s) 96 each initially extend away from stator body 10 in a direction at an angle φ radially outward of the axial direction, and then conductor ends 95, 96 each turn back in a generally radially inward direction as they further extend in a generally axial direction. For example, conductor end turn portion 95 has a secondary bend 97 and conductor end turn portion 96 has a secondary bend 98. By use of such secondary bend portions 97, 98, coolant may be provided between adjacent end turn pairs while minimizing overall radial expansion of stator end turns. FIG. 9H illustrates an alternative exemplary embodiment where conductor end turn portions 85, 86 are oriented in an axial direction. Conductor end turn portion(s) 99 and conductor end turn portion(s) 100 each initially extend away from stator body 10 in a direction at an angle φ radially outward of the axial direction, then conductor ends 99, 100 each turn back in a radially inward direction at respective bends 97, 98 as they further extend in a generally axial direction, and then conductor ends 99, 100 each turn further back at respective bends 101, 102 in a generally radially inward direction as they still further extend in a generally axial direction. Selected angular slot positions may have third bend portions 101, 102 to channel coolant flow and/or to provide different coolant volume at selected stator end turn locations. For example, when a chosen stator wiring configuration has a particular pattern with interwoven conductor segments and differing axial conductor heights, a given angular slot position may have a greater/lesser space for coolant flow in the circumferential and/or axial direction. By utilizing tertiary bend portions 101, 102, coolant flow may be optimized by adding another degree of fluid passage direction. Embodiments may have any number of bend portions to accommodate coolant flow patterns, to direct coolant at hot spots, and to increase conductor end turn surface area for improved heat transfer.

The apex 23 (e.g., FIG. 3B) of each conductor segment 25 in a populated stator core 40 may be located externally of one axial end of stator 2 and welded ends 32, 33 may all be disposed at the other axial end of stator 2. In such a case, the apex ends of conductor segments 25 may be angled radially outward so that such apex end turn portions are somewhat symmetrical with respect to the welded end turn portions at the opposite axial end of stator 2.

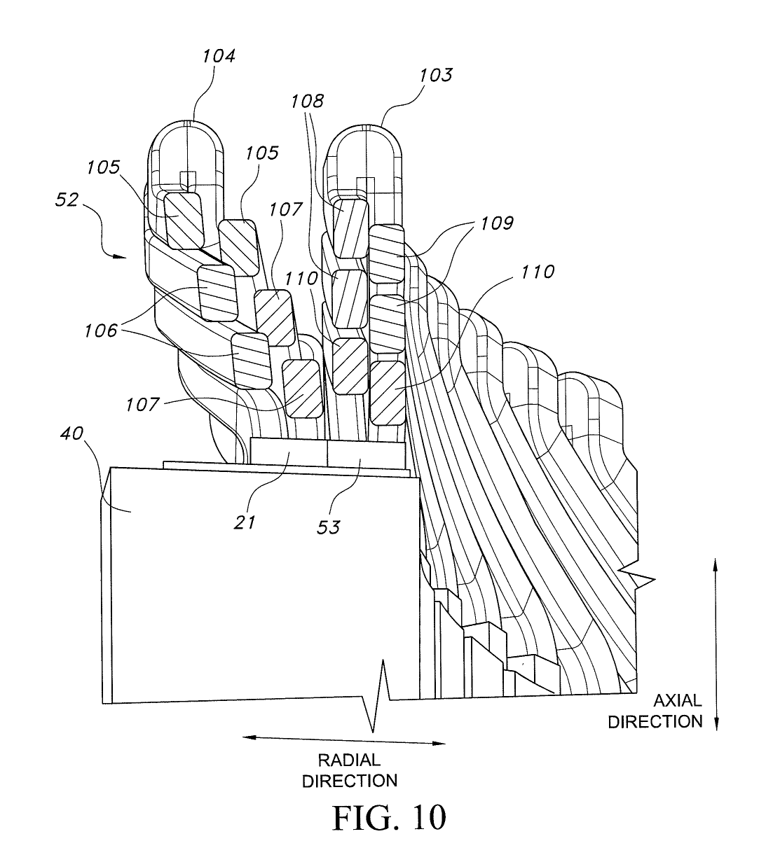

FIG. 10 is a partial perspective cutaway view of a stator assembly 52 of an exemplary embodiment. The cutaway view shows a radially inner end turn 103 and a radially outer end turn 104 at a given angular position 11 (e.g., FIG. 2A). In this example, three separate conductors 105, 106, 107 form end turns that are bent circumferentially to be layered on top of one another as a radially outer group and three separate conductors 108, 109, 110 form end turns that are bent circumferentially to be layered on top of one another as a radially inner group. The radially outer group corresponds to the angular position at sleeve 21 and the radially inner group corresponds to sleeve 53 at the same angular position. Conductors 108, 109, 110 extend as a group axially outward, while conductors 105, 106, 107 extend as a group radially outward at an angle greater than one degree away from the axial direction, and then extend in the axial direction. This general form is shown, for example, in FIG. 9G. All conductors of the stator are bent to this general form at each axial end of stator core 40, so that all end turns are symmetrical as part of corresponding annular rings. As a result of bending end turns 103, 104, oil or other coolant is able to flow easily and directly to each conductor portion thereof. Coolant may thereby be provided to otherwise inaccessible portions at the conductor apex end of a densely packed stator. After all end turn portions at the opposite axial stator end have been welded, they are grasped and bent to substantially the same form, whereby coolant may freely flow to corresponding end turns at the weld end of the stator. In an alternative embodiment, some or all conductor segments may simply be straight wire lengths that are installed into stator core 40, twisted and shaped at each axial end of stator core, welded to adjacent segments to form end turn portions at each axial end of stator core 40. Annular layers of conductor segments are then spread apart to form angles φ, β, or δ, as applicable to the chosen end turn configuration.

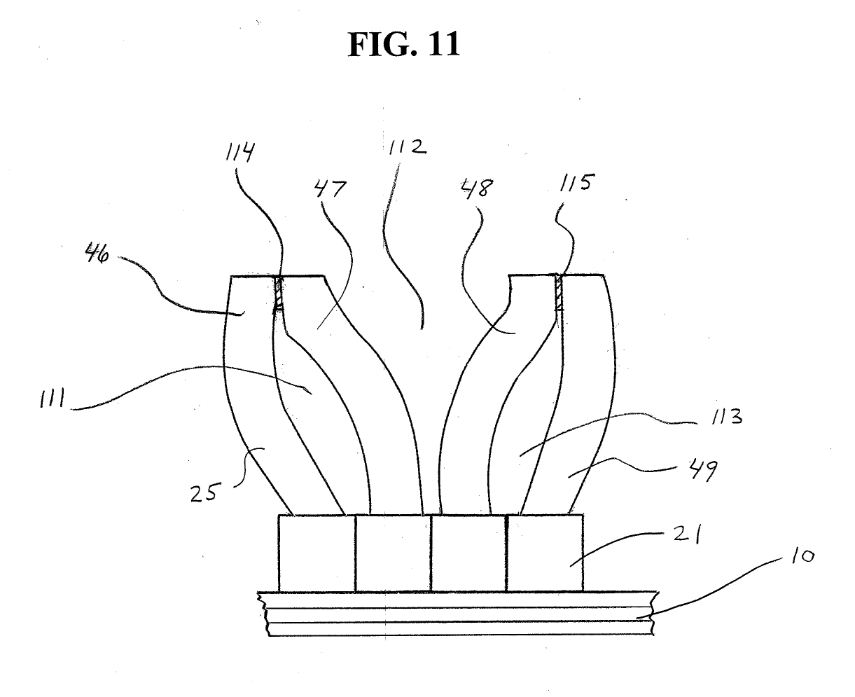

FIG. 11 is an elevation view showing welded end turns in a configuration allowing coolant access to individual conductors. Portions of adjacent conductor ends 46-49 are bent in radially opposite directions, whereby corresponding spaces 111-113 are provided between radially adjacent conductors 25. For example, after conductor bar segment 25 has been installed through lamination stack 10 and slot liner 21, conductor end 46 is gripped and bent so that its axial end has a welding contact surface substantially orthogonal to the radial direction. Likewise, conductor end 47 is gripped and bent to have its distal end in substantial alignment with the welding contact surface of conductor end 46. The other conductor ends 48, 49 are bent in a same manner so that their axial ends have abutting, opposed faces. Conductor ends 46, 47 are welded together at weld 114, and conductor ends 48, 49 are welded together at weld 115. Each radial side of each conductor end turn may thereby be provided access to coolant.

In various applications, additional coating may be performed such as by applying a thermally conductive coating to the radially spread exterior conductor portions.

While various embodiments incorporating the present invention have been described in detail, further modifications and adaptations of the invention may occur to those skilled in the art. However, it is to be expressly understood that such modifications and adaptations are within the spirit and scope of the present invention.

What is claimed is:

1. An electric machine, comprising:
a stator core having a plurality of circumferentially-oriented slot positions, each slot position having a plurality of radially-oriented slots, each slot extending longitudinally through the core;
a plurality of conductor segments each extending through at least one of the slots;
wherein when a slot position is populated with at least two conductor segments, at least two conductor portions protruding from the slot position are angled radially apart from one another by more than one degree.

2. The electric machine of claim 1, wherein at least one exterior conductor portion protruding from the slot position is angled radially outward of the axial direction of the stator core by more than one degree.

3. The electric machine of claim 1, wherein a plurality of the slot positions are each populated with at least three conductor segments.

4. The electric machine of claim 1, wherein a plurality of the slot positions are each populated with at least four conductor segments, and wherein conductor portions of the radially outer two conductor segments exiting each populated slot position are angled radially outward by more than one degree.

5. The electric machine of claim 1, wherein, for each populated slot position, each external axial end of at least one radially outermost conductor segment is angled radially outwardly by more than one degree.

6. The electric machine of claim 5, wherein each conductor segment is a hairpin having an apex and having two legs respectively extending through two of the slots, the apex and ends of the legs extending from opposite axial ends of the stator core.

7. The electric machine of claim 6, wherein at least one pair of leg portions exiting each populated slot position is angled radially outwardly by more than one degree.

8. The electric machine of claim 7, wherein end portions of the pair are welded to one another.

9. The electric machine of claim 6, wherein respective protruding portions of the apex and the legs are angled radially outwardly by more than one degree.

10. A method of forming an electric machine, comprising:
providing a stator core having a plurality of circumferentially-oriented slot positions, each slot position having a plurality of radially aligned slots, each slot extending longitudinally through the core;
placing a plurality of conductor segments through the slots so that at least two legs of the segments protrude from an axial end of the stator core at each populated slot position; and
at each populated slot position, radially angling the protruding portion of at least one of the legs by more than one degree.

11. The method of claim 10, wherein the angling includes axially forcing a wedge between adjacent external conductor portions.

12. The method of claim 10, wherein the wedging includes a plurality of individual wedging events performed sequentially about a circumference of the stator.

13. The method of claim 10, further comprising welding pairs of the protruding legs.

14. The method of claim 13, wherein the angling includes bending the protruding leg pairs prior to the welding.

15. A method of cooling an electric machine, comprising providing coolant access to embedded conductor end turn portions of a stator having circumferentially spaced slot positions by radially spreading conductor portions protruding from populated ones of the slot positions.

16. The method of claim 15, wherein the radially outermost protruding conductor portion at each populated slot position is angled radially outward by more than one degree.

17. The method of claim 15, further comprising welding pairs of the protruding conductor portions together, wherein the radial spreading includes bending radially outermost ones of the welded pairs radially outward by more than one degree.

18. The method of claim 15, further comprising applying coolant to the embedded conductor end turn portions via the access provided therefor.

19. The method of claim 15, wherein the radial spreading includes forming more than one radial bend in radial outermost conductor portions protruding from respective selected ones of the populated slot positions.

20. The method of claim 15, wherein the radial spreading is performed for protruding conductor portions at each axial end of the stator.
